(19) United States
(12) Patent Application Publication
(10) Pub. No.: US 2012/0035992 A1
(43) Pub. Date: Feb. 9, 2012

(54) SYSTEM AND METHOD FOR PRESENTING INFORMATION BASED ON INTELLIGENT BUSINESS CARDS

(76) Inventors: Danny T. Tanaka, San Juan Capistrano, CA (US); Robert K. Oku, Los Angeles, CA (US)

(21) Appl. No.: 12/878,387

(22) Filed: Sep. 9, 2010

Related U.S. Application Data
(60) Provisional application No. 61/371,562, filed on Aug. 6, 2010.

(51) Int. Cl. G06Q 30/00

(52) U.S. Cl. 705/14.4; 705/1.1

(57) ABSTRACT

Methods and apparatus are provided for presenting information based on an intelligent business card. In one embodiment, a method includes receiving presentation data for a customer, the presentation data including an identification number associated with an intelligent business card, and receiving a request for presentation data associated with the identification number of the intelligent business card from the customer, wherein the request is generated based on executable code stored in the intelligent business card. The method may further include transmitting presentation data for the customer associated with the intelligent business card to the customer based on the request.

### CROSS-REFERENCE TO RELATED APPLICATION

This application claims the benefit of U.S. Provisional Application No. 61/371,562 filed Aug. 6, 2010.

### FIELD OF THE INVENTION

The present invention relates generally to directed sales, marketing and management solutions, and more particularly to systems and methods for presenting information based on intelligent business cards.

### BACKGROUND OF THE INVENTION

Traditionally, business cards have been employed to assist in the sale of goods and promotion of business. Much like flyers and other conventional types of advertising, these forms of advertising are limited in the amount of information that can be conveyed to a potential customer. Further, these conventional types of promoting sales may be limited by the customers own memory regarding information conveyed. One conventional approach is to create general information, such as a sales brochure or digital packet, for customers use during a sales visit. These information packets are usually designed prior to a customers visit. This approach, while having the ability to provide information to a customer is limited in the ability of a business to communicate with a customer once the customer has left a retail location. Generalized information packets are usually directed at many different customers, and usually provide only general information.

Another drawback of the conventional methods for promoting business may be due to difficulty in retaining client contact information. Many businesses allow employees to manage their own customer contacts. As such, many businesses lose the ability to provide promotional content to customers with the departure of an sales associate. Previous solutions of creating mailing lists and e-mail distributions, however, typically do not allow for business to customize information provided to customers. Further, many customers disregard many communications that are not personalized. Thus, businesses desire an improved method and device to allow for tracking customer interest, purchases and promotional offers.

Accordingly, there is a desire to improve management of customer information and customer communication following a visit to a business to promote sales.

### BRIEF SUMMARY OF THE INVENTION

Disclosed and claimed herein are methods and apparatus for presenting information based on an intelligent business card. In one embodiment, the method includes receiving, by a server, presentation data for a customer, the presentation data including an identification number associated with an intelligent business card, and receiving a request for presentation data associated with the identification number of the intelligent business card from the customer, wherein the request is generated based on executable code stored in the intelligent business card. The method may further include transmitting presentation data for the customer associated with the intelligent business card to the customer based on the request.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A depicts a simplified system diagram according to one embodiment of the invention;

FIG. 1B depicts a simplified system diagram according to another embodiment of the invention;

FIG. 2 depicts a process for presenting information based on an intelligent business card according to one embodiment of the invention;

FIG. 3 depicts a simplified block diagram of a device according to one embodiment of the invention;

FIG. 4 depicts a process for providing an intelligent business card according to one or more embodiments of the invention;

FIG. 5 depicts a simplified block diagram of an intelligent business card according to one or more embodiments of the invention;

FIG. 6 depicts a graphical representation of the intelligent business card of FIG. 5 according to one embodiment of the invention;

FIG. 7 depicts a graphical representation of data storage according to one embodiment of the invention;

FIG. 8 depicts a graphical representation of a presentation according to one embodiment of the invention;

FIG. 9 depicts a graphical representation of a presentation according to another embodiment of the invention;

FIG. 10 depicts a graphical representation of a user interface for managing data associated with one or more intelligent business cards according to one embodiment of the invention;

FIG. 11 depicts a process for generating a report according to one embodiment of the invention; and

FIG. 12 depicts a graphical representation of a report according to one embodiment of the invention.

### DETAILED DESCRIPTION OF THE EXEMPLARY EMBODIMENTS

### Overview and Terminology

One aspect of the present invention relates to presenting information based on intelligent business cards. In one embodiment, a system and methods are provided for providing an intelligent business card to a customer. An intelligent business card as used herein may relate to one or more of types of devices or storage mediums configured to store a unique identifier and executable code. By way of example, an intelligent business card may relate to one or more of a card having a magnetic strip, card having embedded memory for storage, universal serial bus (USB) memory device, optical disk, etc. Intelligent business cards allow for customers to access personalized data from a business entity. For example, an intelligent business card may relate to a digital business card. In certain embodiments, an intelligent business card may be stored by an electronic device that is associated with a single user, a personal communication device, mobile phone, media player, etc. Each intelligent business card may include preloaded data that may allow for a user to access a server for data provided by an entity (e.g., store, business) that issued the intelligent business card. Preloaded data may relate to an execution file and/or executable code that may launch a browser application on a device for a specific network location (e.g., a server) or micro-site associated with a business based on the identification number of the intelligent business card. In one embodiment, an identification number assigned to the intelligent business card may relate to read-only data that may not be modified by a customer. In that fashion, tampering with the identification number and execution code by a customer may be blocked.

Personalized data may be associated with an intelligent business card based on a customer visit to a store. In addition, an intelligent business card may allow for promotional information to be directed to a customer. In one embodiment, a process is provided for presenting information to a customer based on an intelligent business card. The process may include transmitting information, such as a graphical presentation or audio data, to a customer related to an in-store visit and/or promotional event even after a customer has left the store. In that fashion, information may be accessed by one or more customers based on the intelligent business card.

One advantage of the systems and methods described herein may be that data may be personalized for each customer. Further, intelligent business cards may be manufactured at low cost. As such, it may be advantageous to employ intelligent business cards to assist the sale of goods. As described herein, intelligent business cards may be employed for the sale of jewelry. However, it should also be appreciated that the systems and methods described herein may be employed for the say of automobiles, real estate, high priced goods, and other types of goods in general.

Another aspect of the invention is directed to managing data for customers based on intelligent business cards and data associated with business performance. In one embodiment, a system may be provided to track customer activity, sales associate performance, and customer contact information based on the assignment of intelligent business cards. The system may allow for a business to not only create and update intelligent business cards and presentations for customers based on assignment of intelligent business cards, but also to store purchase history, customer traffic and other tracking data based on intelligent business card identification. Similarly, a business may monitor sales activity and performance based on data generated for customers. In one embodiment, the system and applications to allow for intelligent business cards that may be based on a cloud computing server to operate one or more applications for the service. In that fashion one or more servers may handle an application to store data and host access to presentations. According to another embodiment, control and management of an intelligent business card may be controlled by a manufacturer and/or distributer of the intelligent business cards.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The computer readable code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

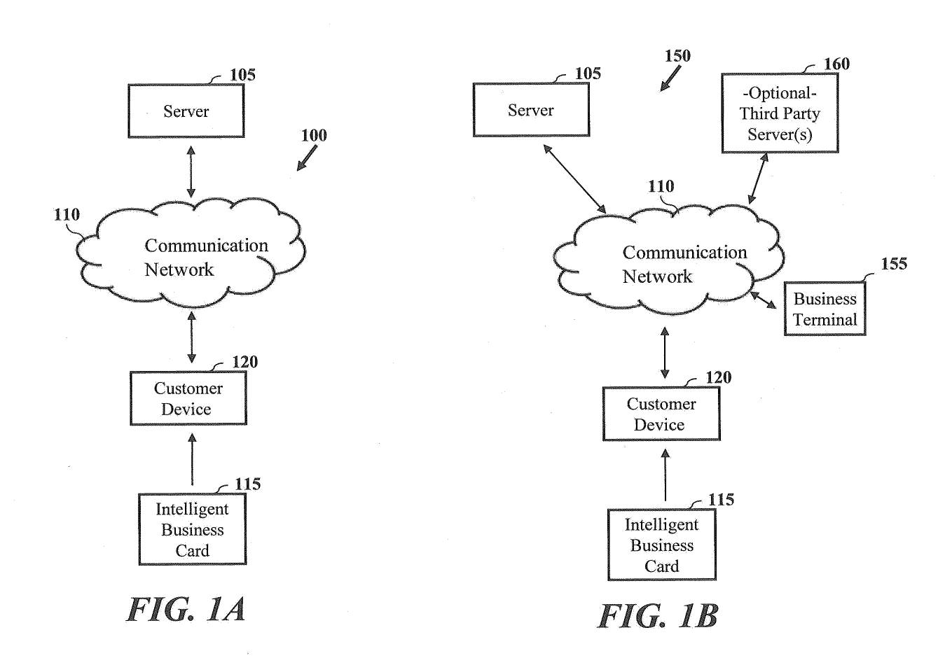

Referring now to the figures, FIGS. 1A-1B depict a simplified system diagrams for providing presentation information based on intelligent business cards. Referring first to FIG. 1A, a simplified system diagram is depicted according to one embodiment. System 100 may be configured to allow customers to access information provided by a business entity based on an intelligent business card. System 100 includes sever 105 configured to manage one or more intelligent business cards and store data associated with use for one or more business entities via communication network 110. Communication network 110 may allow for one or more of wired and wireless communication. For example, communication network may allow for network based communications including but not limited to LAN, WAN, WI-FI, etc.

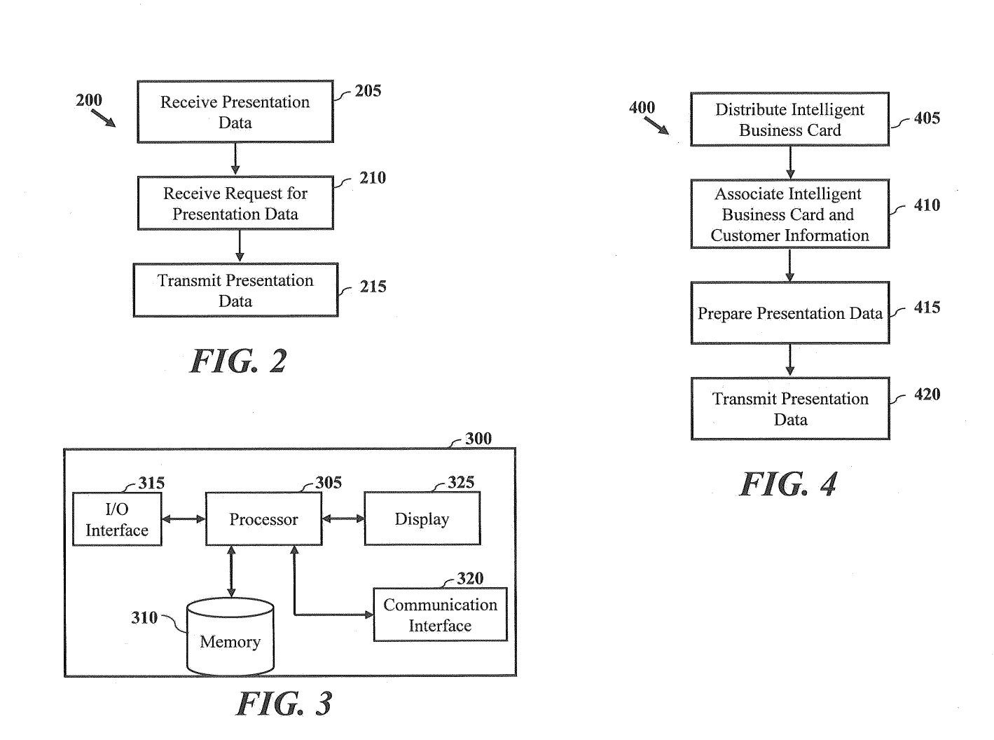

As depicted in FIG. 1A, system 100 includes intelligent business card 115. The intelligent business card may include memory for storage of a unique identification code and executable code. The identification code/number and executable code may be preloaded onto intelligent business card 115 by an entity that manufactures and/or distributes the intelligent business cards. In certain embodiments, one or more of the identification number and executable code may be loaded onto the intelligent business card by a business entity. The executable code stored by intelligent business card 115 may relate to computer readable code that may be read and executable by customer device 120. For example, customer device 120 may relate to a computing device configured to execute the code stored by intelligent business card. As will be discussed in more detail below with respect to FIG. 2, execution of the executable code stored by the intelligent business card may result in transmitting a request to server 105 for presentation data. For example, when the intelligent business card relates to a memory storage device that may be coupled to a computing device, the executable code may be configured to automatically execute upon connection to a device. In that fashion a user may access presentation data by simply coupling the intelligent business card to a computing device, such as customer device 120. It should also be appreciated that executable code stored by the intelligent business card may relate to digital media that may be stored in a device in certain embodiments. A customer may be provided with only one unique intelligent business card having a unique identification number. In that fashion, the unique number may be employed to manage data associated with the intelligent business card, and the customer the intelligent business card is issued to.

Once an intelligent business card has been associated with a customer, the customer may access server 105 via customer device 120. In one embodiment, customer device 120 relates to a computing device, such as a personal computer or laptop configured to communicate via communication network 110 (e.g., the internet, LAN, WAN, etc.). It should also be appreciated that customer device 120 may relate to one or more of a personal communication device (e.g., mobile phone, mobile communication device in general, etc.) to receive data based on an intelligent business card associated with the customer. Further, the customer may utilize the intelligent business card with one or more devices. Based on intelligent business card 115, a customer using customer device 130 may access data produced by a sales associate associated with a business entity. In that fashion, presentation of data may be provided to the user via the intelligent business card. In certain embodiments, intelligent business card 115 may relate to a personal communication device including an unique identifier stored in memory. As such, the intelligent business card may be configured to access data provided by server 105 via communication network 110 directly.

In one embodiment, one or more business entities may employ intelligent business cards for providing promotional content and product information to customers. A business entity may relate to a retail store or business which sells goods. In certain embodiments, the business entity may employ an intelligent business card for business to business sales.

Referring now to FIG. 1B, a simplified system diagram of the system of FIG. 1A is depicted according to another embodiment. System 150 may be configured to allow for one or more business entities to service a plurality of intelligent business cards. As described herein, a business entity may provide an intelligent business card to a customer. For example, issuing the intelligent business card may relate to a sales associate handing a customer an intelligent business card during a sales visit. The sales associate may employ business terminal 155 to notify server 105 that intelligent business card 115 has been issued. For example, business terminal may relate to a computing device employed by a business configured to communicate via communication network 110. According to another embodiment, presentation data may generated and transmitted by a sales associated via business terminal 155 to server 105.

Server 105 may be configured to host and execute an application for managing data associated with one or more intelligent business cards including presentations for customers. In one embodiment, each business entity (e.g., store) may employ a business terminal, such as a computer device for assigning an intelligent business card to a customer. In certain embodiments, business terminal 155 may relate to a cashier terminal. Business terminals 155 may be configured to interoperate with one or more peripheral devices to read data associated with an intelligent business card depending on the type of intelligent business card employed. As will be described below with more detail, intelligent business cards may store a unique identifier and executable code, and can relate to one or more of a card having a magnetic strip, card having embedded memory for storage, universal serial bus memory device, and optical disk.

System 100 may further be configured to manage data associated with customers based on the assignment of an intelligent business card. In one embodiment, business terminals may account for purchases made by scanning or entering an identification number of an intelligent business card. Server 105 may store records of transactions based on customer purchases and sales associate activity to allow for the business entity to account for management of inventory and analysis of performance. Further, server 105 may be configured to collect and analyze data for a plurality of business locations. Storage of customer data, sales, and applications to allow for intelligent business cards may be based on cloud computing servers (e.g., Software as a Service (SaaS) servers). For example, server 105 may host an application and provide storage for managing data associated with intelligent business cards.

System 100 may be configured to provide one or more functions to assist business entities to track sales associates ability for closing sales and providing promotional content to customers. System 100 may further be employed by business entities to track one or more of sales associate performance, customer habits, customer purchase history and inventory. In yet another embodiment, system 100 may further be employed by customers to receive targeted data, review data associated with a sales visit, view promotion material, view customized pricing of products and contact a business entity. In one embodiment, system 100 may employ one or more optional third party servers, shown as 160, which may be employed for one or more of the functions described herein. Optional third party servers 160 may relate to cloud servers which may be configured to host a business entity's internet site and distribute one or more presentations for a customer. In certain embodiments, optional third party servers 160 may be configured to store data associated with one or more intelligent business cards and/or host applications for generating presentation data. Optional third party servers 160 may be configured to provide intelligent business card services in addition or separate from server 105.

As discussed herein, intelligent business cards may be employed for retail sales. In one embodiment, intelligent business cards may be employed for business to business sales, wherein a user defined selector may be provided for a number of products to be offered. In that fashion, a wholesaler or manufacturer may provide entire lines of merchandise in a presentation accessed based on assignment of an intelligent business card. In certain embodiments, the presentation may further include an alert for customers assigned an intelligent business card. By way of example, many industries including the pharmaceutical industry would benefit if manufacturers could provide an alert to customers related to specific products. System 100 may be configured to provide an alert to one or more customers based on intelligent business cards for notices related to one or more products according to one embodiment.

According to another embodiment, intelligent business cards may be provided to allow for consolidation of one or more gift cards and/or rewards points to a single card. For example, in certain embodiments, multiple customer accounts associated with multiple business entities and/or business credits including rewards points, store credit and gift cards may be stored on the intelligent business card for customer use.

FIG. 2 depicts a process for providing data based on an intelligent business card according to one embodiment of the invention. Process 200 may be employed by a server (e.g., server 105) to provide a customer with information, such as a graphical presentation. In one embodiment, presentation information may be provided to include a personalized message directed for a customer by a sales associate based on a previous sales presentation/store visit, and one or more graphical elements identifying one or more of a promotional offer, items offered for sale and customized pricing for one or more products offered for sale. Prevention information may further include audio data, such as a recorded message.

Process 200 may be initiated by a server (e.g., server 105) receiving presentation data at block 205. Transmission of presentation data by a business entity may serve as a notification identifying the assignment of an intelligent business card to a customer. Based on the sales visit of a customer, an employee of the business entity, such as a sales associate, may issue an intelligent business card to a customer. The employee may then generate a presentation for the customer based on the sales visit, promotional events, and/or for communication with the customer.

Intelligent business cards may be selectively provided to customers of a business by sales associates. The intelligent business cards may be employed to increase sales, as a promotion tool, and for communication with customers. As used herein, an intelligent business card relates to an article configured to store at least one identifier. The intelligent business card may further be configured to include an executable program which may be initiated by a user to access a server providing data associated with the unique identification number of the intelligent business card. Intelligent business cards may further relate to one or more of a card having a magnetic strip, card having embedded memory for storage, universal serial bus memory device, and optical disk. Intelligent business cards may be configured to store an identification number for the card which may be associated with a customer and one or more businesses. In order to provide a customer with the ability to receive data associated with a visit to a business, an intelligent business card may be issued to the customer by a sales associate. An employee of the business entity, such as a sales associate, may notify a server of the association and further provide customer contact information to be stored by the server.

In one embodiment, presentations may be generated based on preloaded data and/or templates generated for the sales associate. The employee may then transmit the presentation data to a server. The presentation may additionally include the identification number of an intelligent business card, which the server may employ for generating a micro-site. A server may additionally employ the identification number to respond to customer access requests.

In one embodiment, presentations may be accessed by user activation of an intelligent business card. In another embodiment, presentation data may be provided based on received requests associated with the user executing data stored in the intelligent business card. Process 200 may proceed by the server receiving a request for presentation data associated with intelligent business card based on the identification number at block 210.

The server may be configured to associate customer information to an identifier associated with the intelligent business card. In one embodiment, the customer information may be associated with an identifier of a intelligent business card even though a customer has left the business location. One advantage of the system and methods as described herein may be that data may be provided and/or associated with an intelligent business card without the need for a customer to wait at a store. Customer contact information may relate to one or more of an email address, multimedia messaging service address, telephone number and network address in general. A sales associate may collect customer information when providing the customer with an intelligent business card. One advantage of intelligent business card as described herein, may be that a presentation can be created, loaded, and edited for each client in minimal time even after a customer has left a store.

According to another embodiment, a user may access the server to receive a presentation by simply providing a user terminal with the identification number of the intelligent business card via a network site. For example, a user may access a particular network location or internet address and provide the customer number associated with the intelligent business card. In further embodiments, the intelligent business card may automatically launch a internet site on a users device to provide presentations of data to a customer. Presentation data associated with the customer identifier may be transmitted to the customer at block 215. Presentation data may relate to a graphical display including graphical elements associated with promotional content, the promotional content directed to the customer and further identifying customer odds for a promotional event. In another embodiment, presentation data may relate to a graphical display including graphical elements associated with one or more objects for sale based on a previous sales presentation or store visit by the customer. In another embodiment, presentation data may include one or more graphical elements which may be selected to initiate a communication with a point of sale, such as a selectable link that may initiate communication by the device a customer is operating (e.g., telephone call, email, MMS message, etc.). In certain embodiments, presentation data may further include audio data that may be provided in addition to a graphical display.

According to another embodiment, the server may be configured to store data associated with one or more of customer purchase history, sales associate performance, and product sales based on an intelligent business card. According to another embodiment, user access and/or requests from a server may be tracked by counting hits to the server when a request is received.

FIG. 3 depicts a simplified block diagram of a device according to one embodiment of the invention. Device 300 may be employed by an employee of a business entity to manage one or more intelligent business cards according to one embodiment. In one embodiment, device 300 may be configured to interoperate with one or more servers (e.g., server 105) to provide presentation data for one or more customers having an intelligent business card. As shown in FIG. 3, device 300 includes processor 305, memory 310, input/output (I/O) interface 315, and network communication interface 320. Processor 305 may be configured to control operation of device 300 based on one or more computer executable instructions stored in memory 310. Memory 310 may relate to one of RAM and ROM memories and may be configured to store one or more media files, content, and computer executable instructions for operation of device 300.

I/O interface 315 may include one or more buttons for user input, such as a numerical keypad, volume control, channel control, menu controls, pointing device, track ball, mode selection buttons, and playback functionality (e.g., play, stop, pause, forward, reverse, slow motion, etc). Buttons of I/O interface 315 may include hard and soft buttons, wherein functionality of the soft buttons may be based on one or more applications running on device 300. I/O interface 315 may be configured to allow for one or more devices to communicate with device 300 via wired or wireless communication. I/O interface 315 may include one or more ports for receiving data, including ports for removable memory. In another embodiment, device 300 may be configured to detect and encode/decode one or more intelligent business cards based on media type.

Network communication interface 320 may be configured to allow for network based communications including but not limited to LAN, WAN, Wi-Fi, etc. Display 325 may be employed to display one or more of a user interface for a service account, menu functions, media file identifiers, sources of media files, etc.

According to one embodiment of the invention, an intelligent business card may be provided to a customer during a sales presentation without requiring presentation information to be loaded on the intelligent business card during the customers visit to a location. FIG. 4 depicts a process by an employee of a business entity, such as a sales associate, to provide a customer with an intelligent business card. Process 400 may be initiated by issuing (e.g., distributing) an intelligent business card at block 405. The intelligent business card may be activated prior to distribution to a business entity by a manufacturer and/or distributer of the intelligent business card. Activation of the intelligent business card may be based on the type of media employed. In one embodiment, intelligent business cards may be activated by loading the storage medium with a unique identification number and executable code. In certain embodiments, it may be appreciated that the intelligent business card may be activated by a store employee utilizing a business terminal. For example, activation may relate to recording the identification number assigned to the intelligent business card by the device, or assigning an identification number to an intelligent business card and transmitting a notification to a server managing intelligent business cards for the device. When the intelligent business card relates to read only media, such as a CD-ROM or a memory storage device such as a USB key-fob, an application may be loaded onto the intelligent business card that may be automatically executed when coupled to a computing device. Execution of the application may display a window including presentation data.

At block 410, a customer identification, as supplied by the sales associate, may be associated with in intelligent business card by a server. In certain embodiments, customer information may include an email address, telephone number, messaging address, etc. The business terminal may then associate the customer identification with the intelligent business card. At block 415, the sales associate may prepare presentation data for the customer. Preparation of the presentation data at block 415 may allow for editing of a prior presentation to allow for negotiating within a sale and editing for negotiation outside the initial sale. The presentation data may then be transmitted to the server at block 420.

In certain embodiments, the intelligent business card may not be modified, rather, data of the customer may be transmitted to a server managing the intelligent business cards for the business entity. A benefit of employing intelligent business cards includes the ability to provide a customer with information related to a previous sales discussion even after the customer has left the business location.

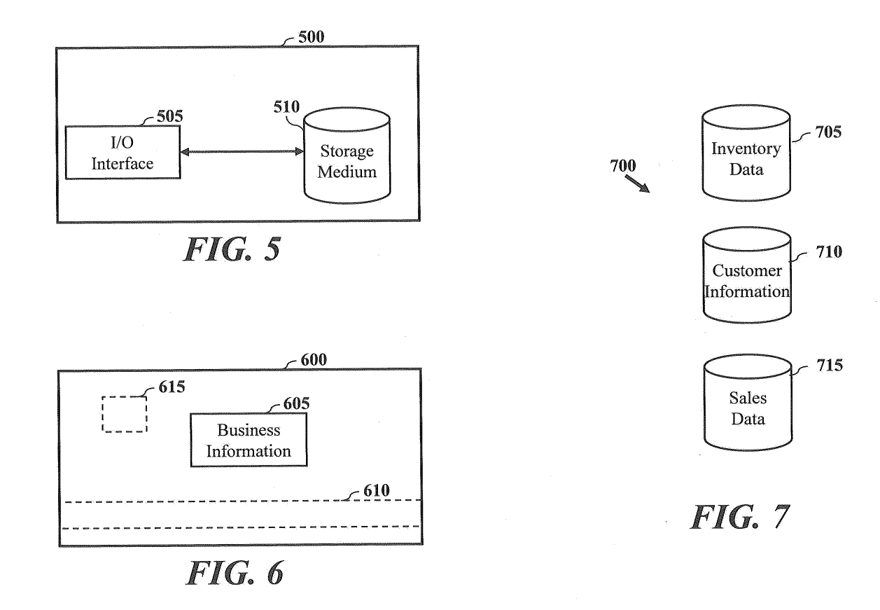

FIG. 5 depicts a simplified block diagram of an intelligent business card according to one or more embodiments of the invention. Intelligent business card 500 may include an input/output interface 505 and storage medium 510. In one embodiment, intelligent business card 500 relates to a plastic card having one or more of a magnetic strip and embedded memory. The magnetic strip may act as both storage medium 510 and I/O interface 505. Similarly, embedded memory of the card may function in a similar manor, wherein the embedded memory may be read via one or more electromagnetic readers to detect a unique identification number assigned to the intelligent business card and executable code. In another embodiment, intelligent business card 500 may relate to an optical disc, wherein the optical media relates to passive storage of an identification number that may be read by a user terminal to access data provided by a business entity.

In another embodiment, intelligent business card 500 may relate to a universal serial bus (USB) memory device, wherein I/O interface 505 relates to a USB terminal and storage medium 510 relates to one or more of ROM and RAM memory. It should also be appreciated that other types of storage mediums and intelligent business card devices may be employed. In certain embodiments, storage medium 510 may be read-only.

FIG. 6 depicts a graphical representation of the intelligent business card of FIG. 5 according to one embodiment of the invention. In particular, FIG. 6 depicts an intelligent business card relating to a plastic card having a magnetic strip. Intelligent business card 600 includes business information shown as 605. Business information 605 may include text and/or graphics to identify one or more of a business entity, sales associate, contact information of the business entity, etc. Intelligent business card 600 further includes magnetic strip 610 which may be read by a magnetic swipe reader. Intelligent business card 600 further includes embedded memory 615 which may be read by a magnetic pass reader.

In addition to providing information to customers, the systems and methods as described herein may be configured to provide data storage for managing customer data, tracking performance, and inventory of products for sale. FIG. 7 depicts a graphical representation of data storage according to one embodiment of the invention. In one embodiment, data 700 employed by the system (e.g., system 100) may be remotely stored. For example, data employed by a business entity may be arranged in one or more storage mediums provided by a third party, such as cloud computing storage. Arrangement of the data may include inventory data 705 related to products available, past products, product attributes and image data associated with one or more products. In certain embodiments, inventory data may be employed for customer presentations. Similarly, inventory data may be employed for customer browsing of a business products. Customer information 710 may relate to customer contact information and purchase history/habits. One advantage of storing customer contact information may allow for business to retain customers even when sales associates are no longer associated with the business entity. According to another embodiment, customer information 710 may further include counter data and/or tracking data identifying the number of visits/request a user has made for presentation data. Sales data 715 may additionally be stored for tracking performance of employees and effectiveness of promotional content, and product sales based on associated with an identification number of the intelligent business card.

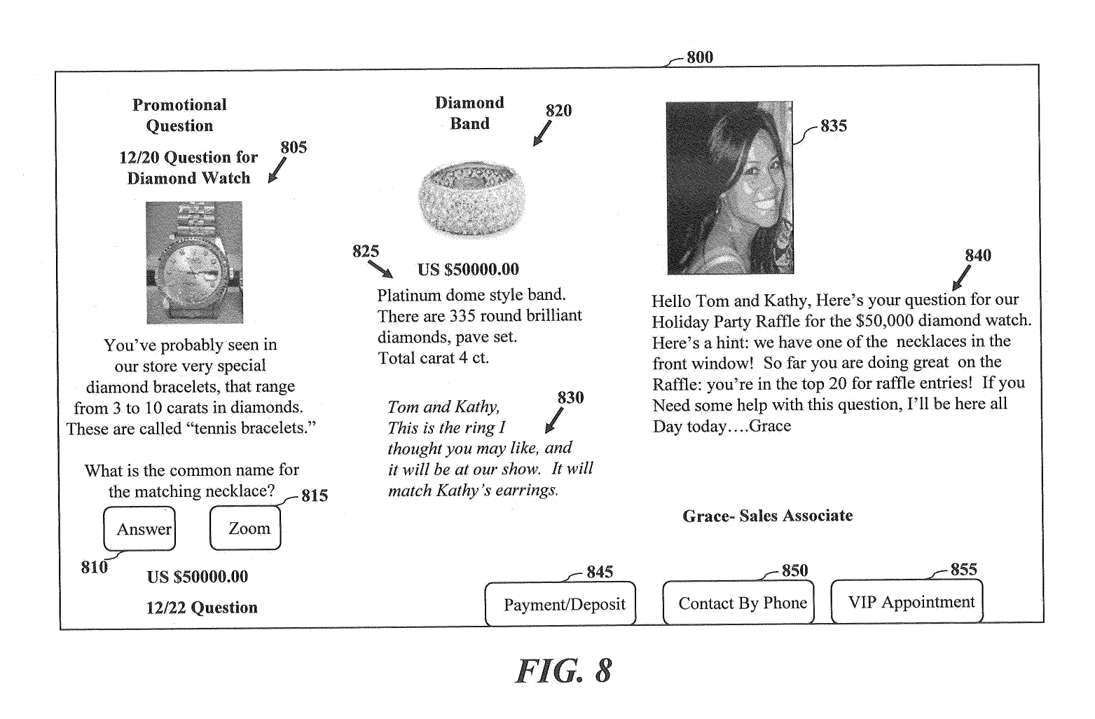

FIG. 8 depicts a graphical representation of presentation data according to one embodiment of the invention. Presentation 800 may be generated for a customer. Incentivized promotional marketing by presentation 800 may provide a customer with reasons to attend a store event by offering a prize or discount for attending the event. Incentivized promotional marketing based on intelligent business cards may provide a unique incentive relative to a businesses competition based on games or question-and-answer sessions a customer may participate in. Promotional events may relate to a store event wherein customers may be invited to bid or purchase raffle tickets for an item or product to benefit a charity. Presentation 800 may be viewed by a customer various times leading up to the in-store event to build interest in the event and further provide marketing of one or more store items. Such a presentation may provide low cost advertising, a unique presentation of promotional content, identification of sale items to a customer, and unique customer sales associate interaction.

Presentation 800 relates to a graphical display which may be viewed by a display of a computing device of the customer. In one embodiment, when a customer executes code of the associated with the intelligent business card, a device the user operates may request that the server transmit data associated with the identification number of the intelligent business card, such as presentation 800. Presentation 800 may be employed to provide promotional data shown as 805. By way of example, promotional data 805 provides a graphical representation of a current raffle and the ability for a customer to increase their chances by correctly answering a question. Accordingly, presentation 800 may relate to an active presentation wherein a customer may submit and answer by clicking on answer button 810. The presentation may further allow for increasing the size of promotional information by selecting zoom button 815. In one embodiment, customer selection of zoom button 815 may result in the display of a pop-up window including promotional information with increased size.

Presentation 800 may further be employed for presenting information related to one or more items associated with a customers visit to a business entity. Product data, shown by 820, relates to a graphical image of a product that may be purchased by a customer including product information shown as 825. One advantage of the system described herein may be that customized pricing may be provided for product 820. Further, an employee may include a message for the customer related to the product shown as 830.

Another advantage of presentation 800 may be to provide additional communication between a business entity and a customer. For example, graphical display of a sales associate image shown as 835 and a personalized message for the customer, shown as 840, may be employed as a directed advertising message to gain customer business.

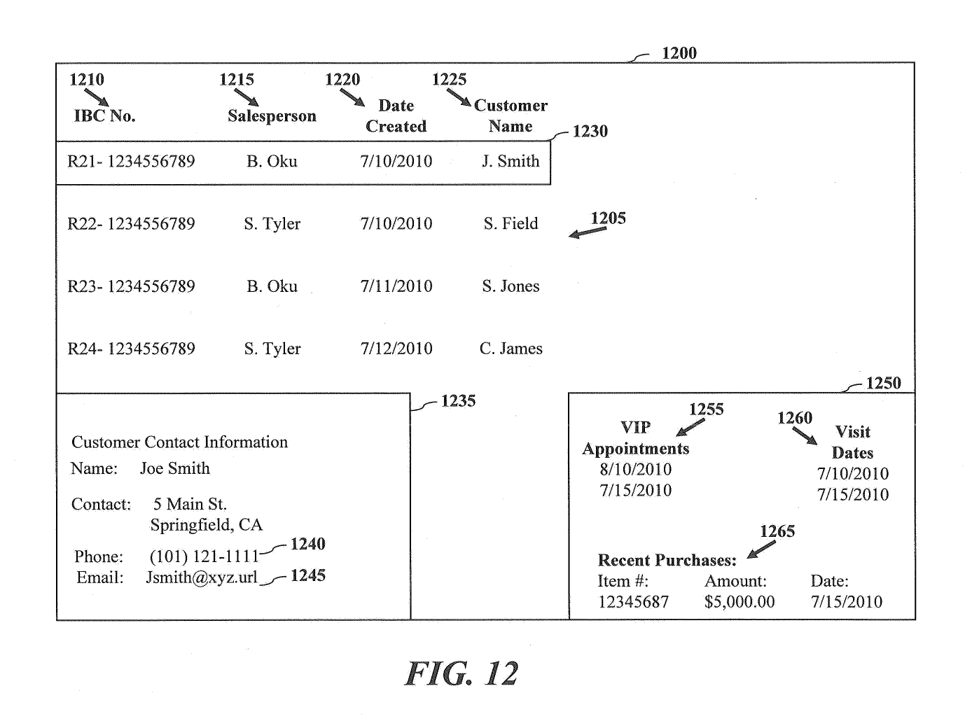

As depicted in FIG. 8, presentation 800 may include one or more selectable elements that may be selected by a user to directly communicate with a business entity. By selection of button 845, a customer may be directed to a network address for making a payment and/or deposit, such as the business entities payment website. Payment/deposit button 845 may allow for a user to purchase an item via communication with a server (e.g., server 105) twenty-four hours a day. Selection of button 850 may allow for direct contact of a voice call to the business entity, for example via the users personal communication device employed to view the presentation. Selection of contact by phone button 850 may result in graphical display of one of more phone numbers designated by a store. In certain embodiments, selection of button 850 may additionally display an email contact address that a user may employ for initiating an email to one or more of a store and sales associate. Selection of VIP appointment shown by button 855 may display a window for arranging an appointment with a sales associate. According to another embodiment of the invention, selection of buttons 845, 850 and 855 may be tracked, or counted by a server (e.g., server 105) to allow for management of customer activity and/or generation of a report as will be discussed below in more detail with respect to FIG. 12. Tracking of user activity associated with the intelligent business card may account for the number of times a user accesses presentation 800. Tracking customer interest may allow for a pro-active closing strategy for sales associates such that repeated customer interest (e.g., high or repeated number of viewing thorough tracked clicks) can prompt the sales associate to change and/or add information for presentation 800. Further, updating and/or changing information provided by the presentation may be performed remotely via a business terminal (e.g., business terminal 155) remotely. In addition to graphical elements, presentation 800 may further include data associated with audio data that may be output by a user when accessing presentation 800. Further, presentation 800 may be created based on one or more templates to facilitate generation for a variety of customers. A template may include one or more windows or regions established for the sales associated to place graphics, text, and communication buttons.

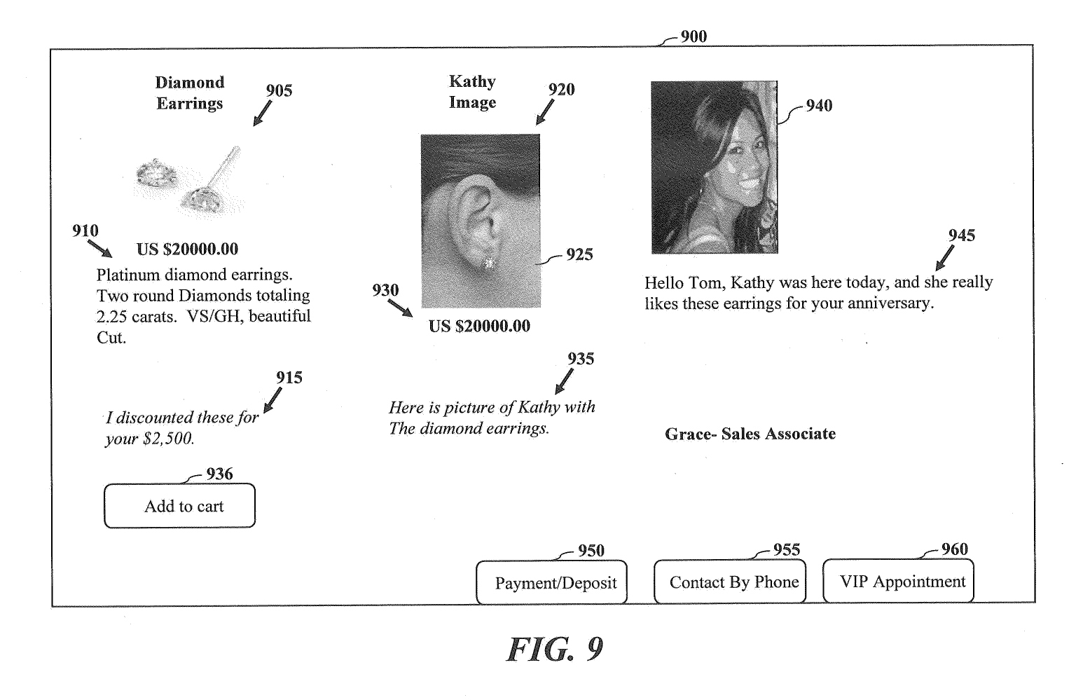

Referring now to FIG. 9, a graphical representation is depicted of a presentation according to another embodiment of the invention. In particular, presentation 900 may be generated for a customer to provide additional information related to a customer visit. For example, presentation 900 may be provided to assist in closing a sale. Similar to the presentation described above (e.g., presentation 800), presentation 900 relates to a graphical display which may be provided by a display of a computing device of the customer. In one embodiment, when a customer executes code stored by the intelligent business card, a server may be accessed for presentation 900. Presentation 900 may include product data, shown as 905. By way of example, product data 905 provides a graphical image of a product that may be purchased by a customer including product information shown as 910. One advantage of the system described herein may be that customized pricing may be provided for a product. Further, an employee may include a message for a customer related to the product, shown as 915.

Another advantage of presentation 900 may be that a business entity may load one or more graphical images, such as image 920 related to a picture of a customer and a product. In particular, image 925 relates to a picture of a customer wearing jewelry and may further include customized pricing of the product for the customer, shown as 930. In certain industries, customized pricing may be valuable, as the pricing for a product may vary and/or may be subject to negotiation between parties. Thus, customized pricing shown as 930, may be valuable for a customer. Presentation 900 may further include a personalized message by the employee associated with image display 920 shown as 935. Presentation 900 may further include an add to cart button 936 which a customer may select to add item 905 to virtual shopping cart for purchase via a communication network. Based on a user selection, a server may provide a user interface elements for receiving user payment information.

Presentation 900 may provide additional communication between a sales associate and a customer via graphical display of a sales associate image, shown as 940, and a personalized message for the customer, shown as 945. Presentation 900 may include one or more selectable elements including button 950 for making a payment to a business entity, button 955 for direct contact of a voice call to the business entity, and button 960 for arranging an appointment with a sales associate. One advantage of the ability to communicate with a customer provided by presentation 900 may be that a sales associate may follow-up on a customers sales visit to assist in closing a sale.

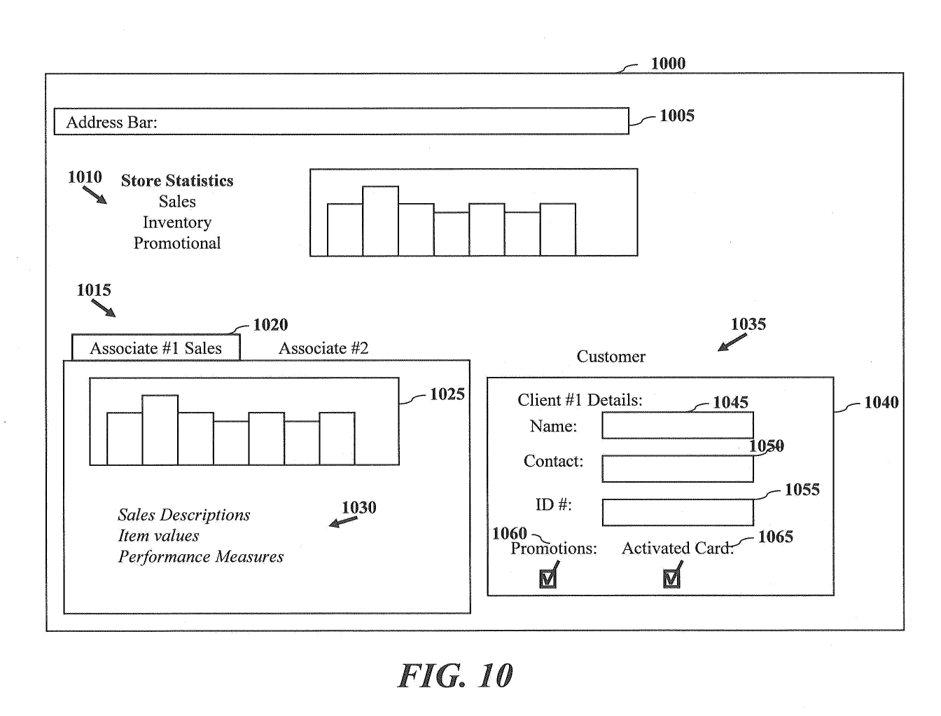

Presentation may 900 may be designed to repeat or include at least a portion of information provided to a customer during an in-store visit. By allowing a customer to access presentation 900 using an intelligent business card at the customers convenience, customer retention of product information may increase in comparison to only receiving information during an in-store visit. Further, access to presentation 900 may be tracked by a server (e.g., server 105) hosting the application of the intelligent business card to allow for a business entity to view client interest. In certain embodiments, a business entity may decide to create one or more presentations, such as presentation 800 and 900, based on user interest. According to one embodiment, presentation 900 may be created by a user interface, such as the user interface described below in FIG. 10 based on one or more preloaded presentation templates.

FIG. 10 depicts a graphical representation of a user interface for managing data associated with one or more intelligent business cards. According to one embodiment, intelligent business cards of a business entity may be managed via a remote server hosting applications for providing customer presentations and storing data associated with intelligent business cards. Accordingly, FIG. 10 depicts a graphical representation of a user interface for managing data associated with intelligent business cards according to one embodiment of the invention. User interface 1000 may be employed by an employee of the business entity for activating/deactivating one or more intelligent business cards, managing data associated with customers, and managing sales associated with sales associates of a business entity. User interface 1000 may include address bar 1005 for access to a server hosting the intelligent business card application (e.g., a network based application). User interface 1000 may further present one or more graphical elements associated with store statistics for a business entity related to sales, inventory and promotions.

As shown by 1015, the user interface may allow for tracking employee performance based on selection of tab 1020. For example, user interface 1000 may display a graphical element associated with the associates sales and data, shown by 1030, related to sales descriptions, item values and performance measures. Similarly, data may be presented for customers as shown by 1035. Client information may be presented in window 1040 for customer name 1045, contact information 1050, and an identification number 1055 of an intelligent business card assigned to the customer. Window 1040 may additionally allow for management of whether a customer prefers to receive promotions as depicted by check box 1060 and whether the intelligent business card is activated, shown by 1065. These customer preferences may be managed by an employee of the business entity.

By collecting sales activity, user interface 1000 can allow for efficient tracking of sales performance without requiring manually tracking. Thus, a business entity may employ user interface 1000 to automatically determine activity and/or efficiency of a sales associate. Similarly, a history of products sales may be provided without requiring manually logging of sales.

According to another embodiment, reports may be generated based on activity of one or more intelligent business cards. Data (e.g., data 700) stored by an application providing functionality for the intelligent business cards may be employed to generate reports to view activity associated with an intelligent business card. Activity associated with item purchases, store visits, and attendance to VIP functions may be tracked by scanning a customers intelligent business card during a visit. Similarly, payments made to a customers account may also be tracked and provided by a report.

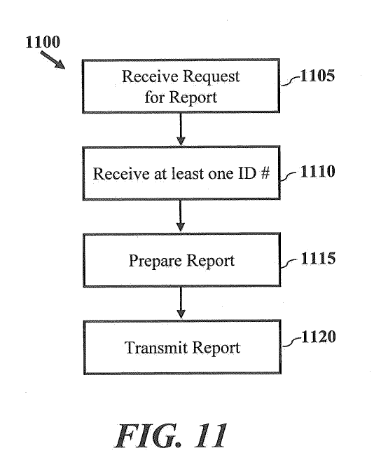

FIG. 11 depicts a process for generating a report according to one embodiment of the invention. In one embodiment, reports may be generated based on three levels, wherein a first level of owners or administrators of the system, which may have access to view all activity. The first level may have control over intelligent business cards. A second level may be provided to managers of a particularly store, these managers may be granted access to all activity for a particular store. A third level may be associated with sales associates (e.g., salespersons), wherein only access to the associate's own activity may be viewed by that associate. In that fashion, proper management and privacy of activity associated with intelligent business cards may be provided. Process 1100 may be initiated by receiving a request for a report at block 1105. The request may be generated by one or more access levels using a business terminal (e.g., business terminal 155) and/or a network connectable device to access a server (e.g., sever 105). The report may further be based on the server receiving at least one identification number at block 1110. The identification number may relate to an employee number, or identification number in general, for one or more of an owner, manager and sales associate. Based on the request and identification number, the server may prepare a report at block 1115 and transmit the report at block 1120 to the device accessing the server. As will be discussed in more detail below with reference to FIG. 12, the report may include a listing of one or more intelligent business cards and provide information related to intelligent business card usage. In one embodiment, the report may be transmitted to the device employed to request a report. It should also be appreciated that generated reports may be stored by the server.

FIG. 12 depicts a graphical representation of a report according to one embodiment of the invention. Report 1200 may be generated by a server (e.g., server 105 and/or third-party server(s) 160) to provide information related to activity of one or more an intelligent business cards. FIG. 12 depicts a report that may be generated for a particular store identifying one or more intelligent business cards, however, it may be appreciated that reports generated for a sales associate may include similar elements. Report 1200 includes a listing, shown as 1205, based on one or more intelligent business cards. The listing may include entries based on an intelligent business card identification number 1210, salesperson name 1215, date created 1220, and customer name 1230 associated with the intelligent business card. According to one embodiment, listing 1205 may present data based on date created field 1220, however it may also be appreciated that report 1200 may be arranged based on other fields. It should also be noted that elements of listing 1205 are exemplary and may be presented in one or more additional formats, in particular identification numbers.

Report 1200 may allow for a user to select one or more entries of listing 1205 as shown by selection box 1230. Based on the user selection, the report may present information associated with the particular intelligent business card. For example, user selection of an entry, shown by 1230, may result in display of customer contact information, shown as 1235, associated with the entry. Customer contact information 1235 may include a name, contact address, phone number 1240 and email 1245. In certain embodiments, phone number 1240 and email 1245 may be selectable by the user in order to initiate a communication to the customer. For example, user selection of email address 1245 may result in an email message window for a user, such as the sales associate, to email the customer.

Report 1200 may further provide data associated with activity of the intelligent business card, shown as 1250. Intelligent business card activity 1250 may include a listing of VIP appointments that have been attended and/or scheduled, shown as 1255, customer visits to a store location, shown as 1260, and recent purchase activity shown as 1265. Recent purchase activity 1265 may include identification of an item number, purchase amount and date of transaction. Information provided by report 1200 may be used by a sales associate and/or store employee to determine whether to initiate contact with a customer to advise on upcoming promotions, and generate sale closing communications.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A method for presenting information data based on an intelligent business card, the method comprising the acts of:
receiving, by a server, presentation data for a customer, the presentation data including an identification number associated with an intelligent business card;
receiving a request for presentation data associated with the identification number of the intelligent business card from the customer, wherein the request is generated based on executable code stored in the intelligent business card; and
transmitting presentation data for the customer associated with the intelligent business card to the customer based on the request.

2. The method of claim 1, wherein the presentation data includes a personalized message for the customer from a sales associate based on a sales presentation and a graphical element identifying one or more of a promotional offer, product offered for sale, and customized pricing for one or more products offered for sale.

3. The method of claim 1, wherein the presentation data relates to a graphical display including at least one of graphical elements and audio data associated with one or more items for sale based on a sales presentation to a customer.

4. The method of claim 1, wherein the presentation data includes one or more graphical elements which may be selected to initiate a communication with a business entity.

5. The method of claim 1, wherein the presentation data relates to a graphical display including graphical elements associated with promotional content, the promotional content directed to the customer and further identifying customer credit for a promotional event.

6. The method of claim 1, wherein the intelligent business card relates to a storage device configured to store the identification number and provide the executable code to a device, the intelligent business card further relating to one of a card having a magnetic strip, card having embedded memory for storage, universal serial bus memory device, optical disk, personal communication device and media player.

7. The method of claim 1, wherein the request relates to a request for data of a micro-site hosted by the server, the micro-site including presentation data provided by a business entity for the customer.

8. The method of claim 1, wherein the presentation data is transmitted to a device that executes the executable code to generate the request.

9. The method of claim 1, further comprising storing data associated with one or more of customer purchase history, sales associate performance, and product sales based on transmitted presentation data.

10. The method of claim 9, further comprising generating a report based on the data associated with one or more of customer purchase history, sales associate performance, and product sales.

11. The method of claim 1, further comprising providing an application interface for at least one of generating the presentation data, managing customer information and tracking sales performance.

12. A system for presenting information based on an intelligent business card, comprising:
an intelligent business card;
a computing terminal configured to execute the executable code stored by the intelligent business card; and
a sever configured to communicate with the computing terminal via a communication network, the server further configured to:
receive presentation data for a customer, the presentation data including an identification number associated with an intelligent business card;
receive a request for presentation data associated with the identification number of the intelligent business card from the customer, wherein the request is generated based on executable code stored in the intelligent business card; and
transmit presentation data for the customer associated with the intelligent business card to the customer via the computing terminal based on the request.

13. The system of claim 12, wherein the presentation data includes a personalized message for the customer from a sales associate based on a sales presentation and a graphical element identifying one or more of a promotional offer, product offered for sale, and customized pricing for one or more products offered for sale.

14. The system of claim 12, wherein the presentation data relates to a graphical display including at least one of graphical elements and audio data associated with one or more items for sale based on a sales presentation to a customer.

15. The system of claim 12, wherein the presentation data includes one or more graphical elements which may be selected to initiate a communication with a business entity.

16. The system of claim 12, wherein the presentation data relates to a graphical display including graphical elements associated with promotional content, the promotional content directed to the customer and further identifying customer credit for a promotional event.

17. The system of claim 12, wherein the intelligent business card relates to a storage device configured to store the identification number and provide the executable code to a device, the intelligent business card further relating to one of a card having a magnetic strip, card having embedded memory for storage, universal serial bus memory device, optical disk, personal communication device and media player.

18. The system of claim 12, wherein the request relates to a request for data of a micro-site hosted by the server, the micro-site including presentation data provided by a business entity for the customer.

19. The system of claim 12, wherein the presentation data is transmitted to a device that executes the executable code to generate the request.

20. The system of claim 12, wherein the server is further configured to store data associated with one or more of customer purchase history, sales associate performance, and product sales based on transmitted presentation data.

21. The system of claim 12, wherein the server is further configured to generate a report based on the data associated with one or more of customer purchase history, sales associate performance, and product sales.

22. The system of claim 12, wherein the server is further configured to provide an application interface for at least one of generating the presentation data, managing customer information and tracking sales performance.

23. A computer program product stored on computer readable medium including computer executable code for presenting information based on an intelligent business card, the computer program product comprising:
computer readable code to receive a notification identifying an assignment of an intelligent business card to a customer;
computer readable code to receive presentation data for a customer, the presentation data including an identification number associated with an intelligent business card;
computer readable code to receive a request for presentation data associated with the identification number of the intelligent business card from the customer, wherein the request is generated based on executable code stored in the intelligent business card; and
computer readable code to transmit presentation data for the customer associated with the intelligent business card to the customer based on the request.

24. The computer program product of claim 23, wherein the presentation data includes a personalized message for the customer from a sales associate based on a sales presentation and a graphical element identifying one or more of a promotional offer, product offered for sale, and customized pricing for one or more products offered for sale.

25. The computer program product of claim 23, wherein the presentation data relates to a graphical display including at least one of graphical elements and audio data associated with one or more items for sale based on a sales presentation to a customer.

26. The computer program product of claim 23, wherein the presentation data includes one or more graphical elements which may be selected to initiate a communication with a business entity.

27. The computer program product of claim 23, wherein the presentation data relates to a graphical display including graphical elements associated with promotional content, the promotional content directed to the customer and further identifying customer credit for a promotional event.

28. The computer program product of claim 23, wherein the intelligent business card relates to a storage device configured to store the identification number and provide the executable code to a device, the intelligent business card further relating to one of a card having a magnetic strip, card having embedded memory for storage, universal serial bus memory device, optical disk, personal communication device and media player.

29. The computer program product of claim 23, wherein the request relates to a request for data of a micro-site hosted by the server, the micro-site including presentation data provided by a business entity for the customer.

30. The computer program product of claim 23, wherein the presentation data is transmitted to a device that executes the executable code to generate the request.

31. The computer program product of claim 23, further comprising computer readable code to store data associated with one or more of customer purchase history, sales associate performance, and product sales based on transmitted presentation data.

32. The computer program product of claim 23, further comprising computer readable code to generate a report based on the data associated with one or more of customer purchase history, sales associate performance, and product sales.

33. The computer program product of claim 23, further comprising computer readable code to provide an application interface for at least one of generating the presentation data, managing customer information and tracking sales performance
